(19) United States
(12) Patent Application Publication
(10) Pub. No.: US 2021/0276408 A1
(43) Pub. Date: Sep. 9, 2021

(54) Transmission Arrangement For A Transmission Of A Vehicle Or The Like

(71) Applicant: ZF FRIEDRICHSHAFEN AG, Friedrichshafen (DE)

(72) Inventors: Steffen MATSCHAS, Bad Bocklet (DE); Michael ROSKE, Friedrichshafen (DE); Bernd UNSELD, Ravensburg (DE); Thomas DÖGEL, Nüdlingen (DE); Andreas ORLAMÜNDER, Schonungen (DE); Thomas ROSEMEIER, Meckenbeuren (DE)

(21) Appl. No.: 16/490,317

(22) PCT Filed: Feb. 2, 2018
(86) PCT No.: PCT/EP2018/052623

§ 371 Date: Oct. 11, 2019

(30) Foreign Application Priority Data
Mar. 2, 2017 (DE) 10 2017 203 459.9

(51) Int. Cl. B60K 6/48; B60K 6/405; B60K 6/387; F16F 15/14; F16F 15/134

(52) U.S. Cl. CPC B60K 6/48; B60K 6/405; B60K 6/387; B60K 2006/4825; F16F 15/13469; B60Y 2200/92; F16F 15/145

(57) ABSTRACT

A transmission arrangement for a transmission of a vehicle or the like includes a dividing housing element configured to divide the transmission arrangement into at least one wet space and at least one dry space, at least one torsional damper for damping torsional vibrations, at least one disconnecting device for disconnecting the torque flow of a drive from a transmission input shaft of the transmission, and a mass damper device. The mass damper device is arranged in the torque flow between the secondary side of the at least one torsional damper and the primary side of the disconnecting device. At least one torsional damper is arranged in the dry space, and at least one disconnecting device is arranged in the wet space, and a connection device for an electric machine is arranged in radial direction above at least one of the devices in the same axial plane.

### CROSS REFERENCE TO RELATED APPLICATIONS

This is a U.S. national stage of application No. PCT/EP2018/052623, filed on Feb. 2, 2018. Priority is claimed on German Application No. DE102017203459.9, filed Mar. 2, 2017, the content of which is incorporated here by reference.

### 1. FIELD OF THE INVENTION

The present invention is directed to a transmission arrangement for a transmission of a vehicle or the like, comprising a dividing housing element which is configured to divide the transmission arrangement into at least one wet space and at least one dry space, at least one torsional damper for damping torsional vibrations, at least one disconnecting device for disconnecting the torque flow of a drive from a transmission input shaft of the transmission, and a mass damper device.

The invention is further directed to a transmission arrangement for a transmission of a vehicle or the like, comprising a dividing housing element which is configured to divide the transmission arrangement into at least one wet space and at least one dry space, at least one torsional damper for damping torsional vibrations, and at least one disconnecting device for disconnecting the torque flow of a drive from a transmission input shaft of the transmission.

### 2. BACKGROUND OF THE INVENTION

Transmission parts, for example, in a motor vehicle, must be supplied with lubricant in order to keep frictional losses as low as possible on the one hand and to allow cooling of the transmission parts on the other hand. Further, known transmission arrangements comprise, for example, a torsional damper for damping torsional vibrations, a disconnect clutch and possibly a mass damper. As a result of the increasing number of hybrid vehicles, not only must the lubricants be supplied and a damping of vibrations carried out in scanty maximum installation space, but an electric machine must also be connected to the transmission.

Known transmission arrangements are disadvantageous in that, for one, a sufficient decoupling of rotational irregularities is not ensured, or they can only be arranged at all by acquiescing to considerable additional installation space. A further disadvantage consists in that these are essentially “isolated applications”, that is, special cases that cannot easily be applied to different fields.

Therefore, it is an object of the present invention to provide a transmission arrangement which ensures a decoupling of rotational irregularities while at the same time remaining neutral with respect to installation space and, moreover, has a greater flexibility with respect to adapting to different boundary constraints.

### SUMMARY OF THE INVENTION

In a transmission arrangement for a transmission, comprising a dividing housing element which is configured to divide the transmission arrangement into at least one wet space and at least one dry space, at least one torsional damper for damping torsional vibrations, at least one disconnecting device for disconnecting the torque flow of a drive from a transmission input shaft of the transmission, and a mass damper device, wherein the mass damper device is arranged in the torque flow between the secondary side of the at least one torsional damper and the primary side of the disconnecting device, the above-stated object is met by the present invention in that at least one torsional damper is arranged in the dry space, and at least one disconnecting device is arranged in the wet space, and wherein a connection device is arranged for an electric machine and is operatively connected on its radial inner side to a radial outer side of at least one of the devices, in particular is arranged in the same axial plane as the at least one device.

In a transmission arrangement for a transmission, comprising a dividing housing element which is configured to divide the transmission arrangement into at least one wet space and at least one dry space, at least one torsional damper for damping torsional vibrations, and at least one disconnecting device for disconnecting the torque flow of a drive from a transmission input shaft of the transmission, the above-stated object is likewise met by the present invention in that at least one torsional damper is arranged in the dry space and at least one disconnecting device is arranged in the wet space, and in that a connection device for an electric machine is arranged in the wet space, wherein the connection device extends in radial direction and is arranged adjacent to the disconnecting device in axial direction, particularly on the secondary side of the disconnecting device.

One of the advantages achieved in this way is that a sufficient decoupling of rotational irregularities is ensured. A further advantage consists in that a compact axial installation space is made possible. Beyond this, flexibility is increased so that the transmission arrangement can be adapted to a wide range of boundary constraints.

Further features, advantages and preferred embodiment forms of the invention are described in the following or are made apparent thereby.

The mass damper device is advantageously arranged in a dry space. On the one hand, this facilitates maintenance and, on the other hand, makes it possible to transmit force directly from the torsional damper to the mass damper device.

The mass damper device is advantageously configured to damp vibrations of at least a first order, particularly a first order and a second order. This makes possible an improved vibration damping. For example, vibrations due to a cylinder deactivation, for example, two of four cylinders, can also be taken into account.

The mass damper device is advantageously connected on one side to the disconnecting device. This allows the mass damper device to be fastened to the disconnecting device in a reliable and simultaneously simple and cost-effective manner.

The torsional damper advisably has a wobble-compensating connection element in the torque flow on its secondary side. A wobble-compensating connection element can reduce stress on component parts, which prolongs their service life.

The torsional damper advantageously has an added mass element in the torque flow on its secondary side. This provides an additional mass inertia which, for example, minimizes or prevents gear teeth noises or the like and also enhances the decoupling quality of the torsional damper depending on requirements.

A radial offset between a driveshaft, which is connected to the primary side of the torsional damper, and an input element of the disconnecting device can advisably be compensated by the torsional damper. Accordingly, an elaborate, cost-intensive compensation of a radial offset between the driveshaft and the input element of the disconnecting device further transmission parts can be dispensed with.

The connection device is advantageously connected to the secondary side of the disconnecting device. A substantially direct connection of the electric machine to the transmission input shaft is made possible in this way.

The disconnecting device is advisably constructed in the form of a clutch. Accordingly, a disconnecting device can be provided in a reliable and cost-effective manner.

In an advantageous manner, the secondary side of the clutch is formed by an outer plate carrier and the primary side is formed by an inner plate carrier. The connection device can be coupled to the clutch in a particularly simple manner in this way.

A primary side element of the disconnecting device and the mass damper device are advisably supported in the dividing housing element, particularly in the form of an end shield, particularly via a grooved ball bearing. This provides a compact axial bearing support.

The dividing housing element is advantageously arranged in such a way that the wet space forms an interior space of the transmission. Accordingly, a dry space and wet space are provided for the transmission arrangement in a simple manner.

The mass damper device is advisably arranged substantially in radial direction inside of the maximum radial extent of the torsional damper, particularly substantially in the same axial plane. A particularly compact axial installation space is achieved in this way.

In a preferred transmission arrangement, the torsional damper advantageously has a wobble-compensating connection element in the torque flow on a secondary side. Stress on component parts can be reduced by means of a wobble-compensating connection element, which prolongs their service life.

The connection device is advisably constructed as a spur pinion and, in particular, at least one rotational axis of the spur pinion is arranged in radial direction within the maximum radial extent of the disconnecting device. The connection device can accordingly be arranged adjacent to the disconnecting device in axial direction in a simple manner.

An input element of the disconnecting device is advantageously supported by a pilot bearing in a shaft which is connected to the primary side of the torsional damper. A simple bearing support, for example, of the input hub of the disconnecting device, is made possible in this way. It is no longer necessary for a radial offset to be compensated by the torsional damper.

The dividing housing element is advisably supported by a) a thrust sleeve and at least one sealing element or b) a thrust ring and a thrust bearing. Accordingly, a radial bearing support, for example, in the end shield, can be dispensed with.

The disconnecting device advantageously comprises at least one actuating element, and a sealing element and/or a running surface of the actuating element are fastened to the primary side of the disconnecting device, preferably by laser welding. Accordingly, for example, piston seals and/or piston running surfaces can be fastened to an outer plate carrier of a clutch and the actuating piston thereof in a simple manner.

The secondary side of the disconnecting device is advantageously connected via a rivet connection to a hub, and a spline for connecting to further elements, particularly a transmission input shaft, is arranged at the radial inner side and outer side of the hub, respectively. Accordingly, for example, the inner plate carrier of a clutch can be connected via a rivet assembly to a hub part and to further elements, for example, a transmission input shaft, in a simple manner.

Other important features and advantages of the invention will be apparent from the dependent claims, drawings and accompanying description of the figures referring to the drawings.

It will be understood that the features mentioned above and the features to be described below are applicable not only in the respective combination indicated but also in other combinations or in isolation without departing from the scope of the present invention.

### BRIEF DESCRIPTION OF THE DRAWINGS

Preferred constructions and an embodiment forms of the invention are shown in the drawings and are described more fully in the following description Like reference numerals designate like or similar or functionally like structural component parts or elements.

The drawings show schematically:

FIG. 1 a transmission arrangement according to an embodiment form of the present invention;

FIG. 2 a transmission arrangement according to an embodiment form of the present invention;

FIG. 3 a transmission arrangement according to an embodiment form of the present invention;

FIG. 4 a transmission arrangement according to an embodiment form of the present invention; and

FIG. 5 a transmission arrangement according to an embodiment form of the present invention.

### DETAILED DESCRIPTION OF THE PRESENTLY PREFERRED EMBODIMENTS

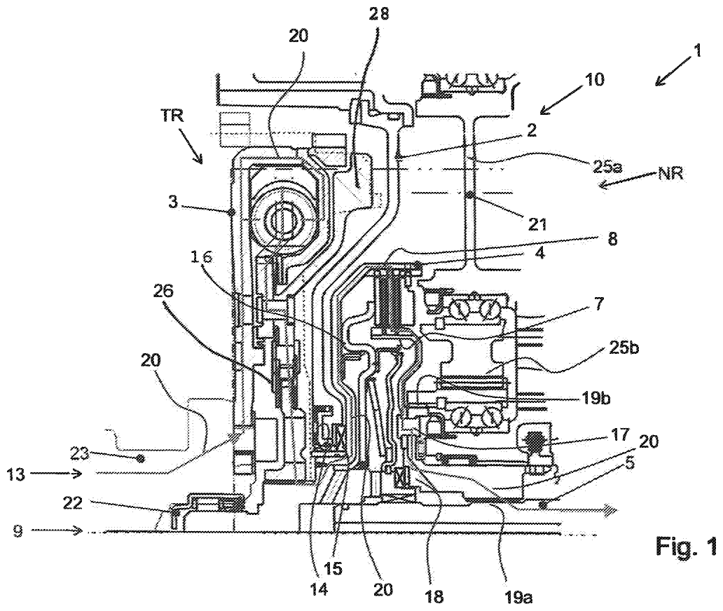

FIG. 1 shows a transmission arrangement according to an embodiment form of the present invention.

FIG. 1 shows a transmission arrangement 1. Transmission arrangement 1 has a dividing housing element or an end shield 2 which divides transmission arrangement 1 into a dry space TR, shown on the left-hand side in FIG. 1, and a wet space NR, shown on the right-hand side in FIG. 1. A dual mass flywheel 3 which is connected to an input hub of a disconnecting device or disconnect clutch 4 is arranged in the dry space TR. The input hub of disconnect clutch 4 is further connected to an outer plate carrier 8. The input hub of disconnect clutch 4 is supported on the one hand in the crankshaft journal of the crankshaft 13 via a pilot bearing 22 and, on the other hand, is supported in the end shield 2 via a thrust bearing 15 in the form of a needle thrust bearing together with a thrust ring 14 and a radial shaft sealing ring. Disconnect clutch 4 comprises, in addition to outer plate carrier 8, a corresponding inner plate carrier 7 which is connected on its secondary side to a hub 18 via a rivet connection 17. The hub 18 has on the radially outer side a spline 19b to a gear wheel with running gear teeth and a further spline 19a to a transmission input shaft 5 in the radially inner area.

A connection device 10 in the form of a spur pinion which serves to connect an electric machine (not shown here) is arranged in axial direction and downstream of disconnect clutch 4 with respect to torque. To this end, two spur gears 25a, 25b are arranged in radial direction to cooperate with one another. The two spur gears 25a, 25b are connected to inner plate carrier 7 of disconnect clutch 4 via a rivet 17 for transmitting torque. For example, torque is transmitted by the first spur gear 25a which is supported substantially in radial direction at the level of the springs of dual mass flywheel 3 (reference numeral 21) on spur gear 25b which lies farther radially inward and which has running gear teeth. Finally, the torque is transmitted to transmission input shaft 5 via spline 19b and second spline 19a, mentioned above.

Overall, the torque flow 20 in FIG. 1 is as follows: proceeding from the driveshaft 9 in the form of a crankshaft 13, the torque is transmitted to the primary side of dual mass flywheel 3 via a crankshaft flange 23. On the secondary side, the torque is then transmitted from dual mass flywheel 3 to outer plate carrier 8 of disconnect clutch 4 and then to inner plate carrier 7 when disconnect clutch 4 is closed. Finally, inner plate carrier 7, as secondary side of disconnect clutch 4, transmits torque to transmission input shaft 5 via a rivet connection 17. Additionally or alternatively, the torque from the electric machine (not shown here) can be transmitted to the transmission input shaft 5 via spur pinion 10 and spline 19b and 19a.

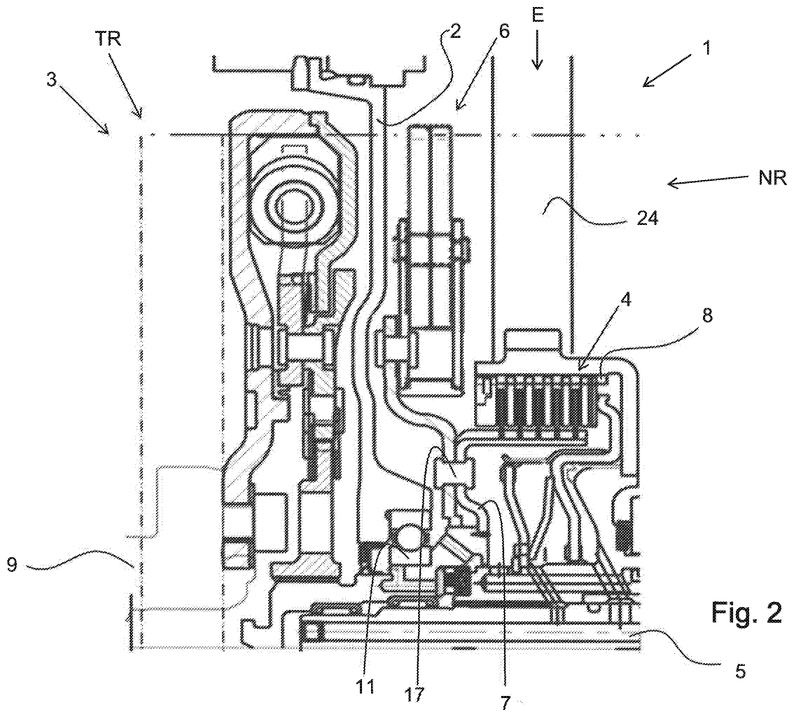

FIG. 2 shows a transmission arrangement according to an embodiment form of the present invention.

FIG. 2 shows a transmission arrangement 1 comprising a dual mass flywheel 3 which is connected on its primary side to a driveshaft 9. Transmission arrangement 1 is divided by an end shield 2 into a dry space TR and a wet space NR. Dual mass flywheel 3 is arranged in dry space TR. The secondary side of dual mass flywheel 3 is operatively connected to an input element of a disconnect clutch 4. Disconnect clutch 4 comprises an inner plate carrier 7 on its primary side and an outer plate carrier 8 on the secondary side. A mass damper device 6 is arranged or fastened at one side to inner plate carrier 7 via a rivet connection 17. Mass damper device 6 and disconnect clutch 4 are arranged in wet space NR. Further, a portion of a connection device is arranged in the form of a chain 24 for an electric machine (not shown here). Chain 24 can also be any other transmission medium such as a toothed belt or a flat belt acting on outer plate carrier 8 of disconnect clutch 4. Outer plate carrier 8 is fixedly connected to transmission input shaft 5.

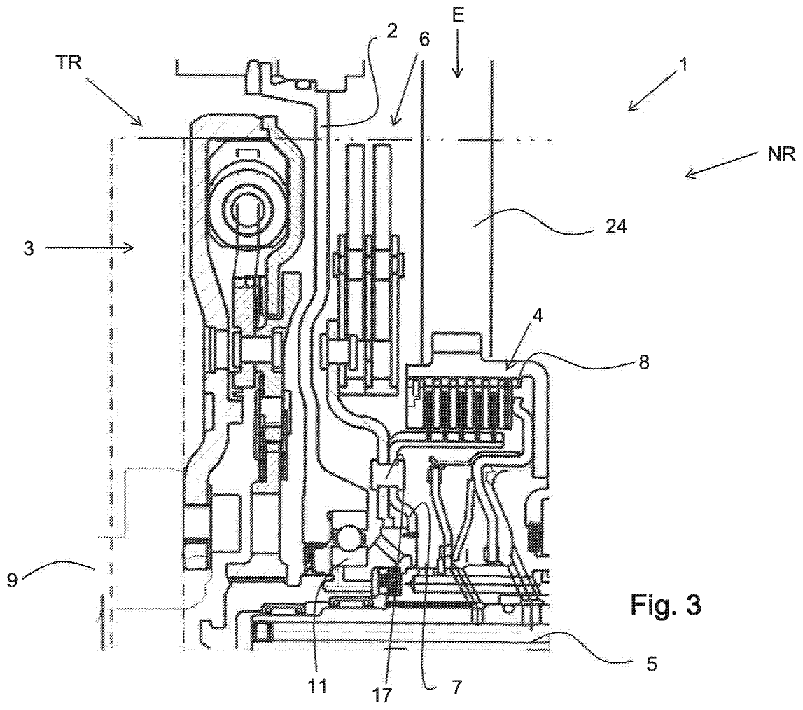

FIG. 3 shows a transmission arrangement according to an embodiment form of the present invention.

FIG. 3 shows an embodiment form substantially according to FIG. 2. In contrast to the embodiment form of FIG. 2, the mass damper device 6 in the embodiment example of FIG. 3 is configured to damp not only vibrations of the first order but also vibrations of the second order.

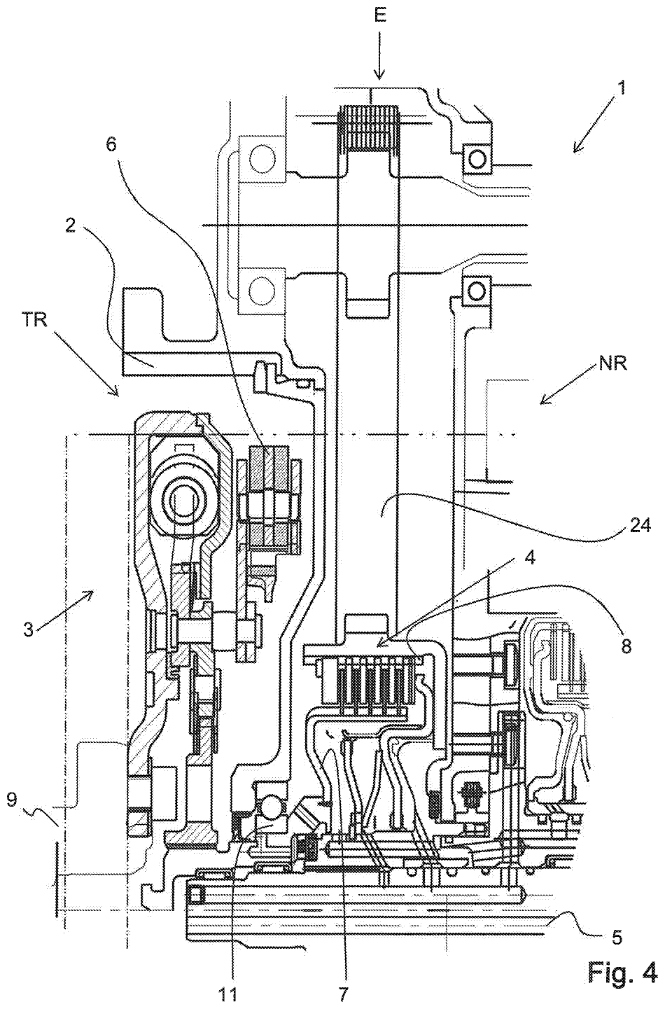

FIG. 4 shows a transmission arrangement according to an embodiment form of the present invention.

FIG. 4 shows an embodiment form substantially according to FIG. 3. In contrast to the embodiment form of FIG. 3, the mass damper device 6 in the embodiment form of FIG. 4 is arranged not at inner plate carrier 7 but rather at dual mass flywheel 3, more precisely, at the secondary side of dual mass flywheel 3. Dual mass flywheel 3 and mass damper device 6 are arranged in dry space TR, whereas chain 24 and disconnect clutch 4 are arranged in wet space NR.

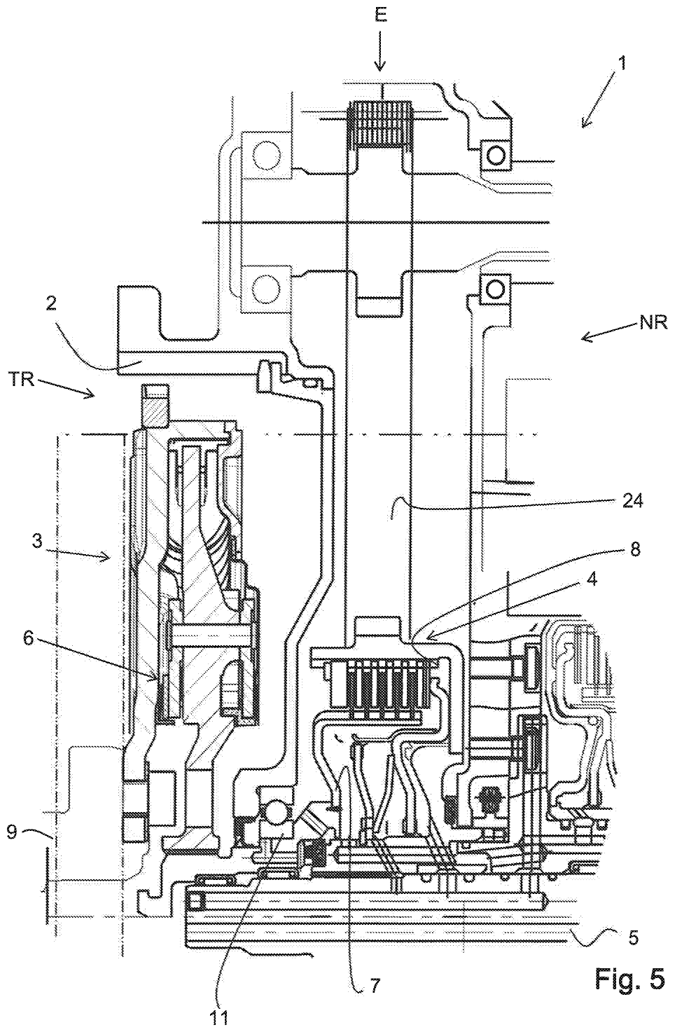

FIG. 5 shows a transmission arrangement according to an embodiment form of the present invention.

FIG. 5 shows an embodiment form substantially according to FIG. 4. In contrast to the embodiment form of FIG. 4, the mass damper device 6 in the embodiment form of FIG. 5 is arranged in radial direction inside of dual mass flywheel 3. As in FIG. 4, mass damper device 6 and dual mass flywheel 3 are arranged in dry space TR.

In the embodiment forms of FIGS. 2-5, in contrast to the embodiment form of FIG. 1, the driveshaft, the input shaft, which is connected to inner plate carrier 7 of disconnect clutch 4, and the mass damper device 6 connected to the latter are supported in end shield 2 via a grooved ball bearing 11. Further, a radial shaft sealing ring can be arranged for sealing wet space NR, and one or more oil channels for lubrication and cooling thereof for centrifugal force compensating space and for clutch actuation.

To summarize, the invention in at least one of its embodiment forms makes possible or makes available the following, separately or in combination:
1. A transmission arrangement with a torsional damper in the dry space and a disconnect clutch for the electric machine in the wet space. The wet space can also be an interior space of the transmission.
2. The primary side of the torsional damper can be connected to the crankshaft, and the secondary side can be connected via a spline to an input hub of the disconnect clutch. The input hub of the disconnect clutch can receive an inner plate carrier, a mass damper device being arranged at the inner plate carrier or input hub so as to be pre-centered.
3. A disconnect clutch can separate an internal combustion engine from the transmission input shaft, for example.
4. A drive by means of an electric machine can act on a plate carrier, particularly on the outer plate carrier, of a disconnect clutch, via a chain or by means of any other transmission medium, for example, a toothed belt, flat belt or the like, and the corresponding plate carrier is then fixedly connected to the transmission input shaft.
5. The mass damper device can be adapted for first-order damping or second-order damping, for example, in order to take into account a cylinder deactivation of four to two cylinders.
6. Compact bearing support of the driveshaft, the input hub with plate carrier of the disconnect clutch and the mass damper device via a compact grooved ball bearing in an end shield. Further, a radial shaft sealing ring can be arranged for sealing the wet space, one or more oil channels for lubrication and cooling thereof for the centrifugal force compensating space and for clutch actuation or KO actuation.
7. Compensation of a radial offset between crankshaft and teeth of the input hub of the disconnect clutch by means of the torsional damper.
8. The torsional damper can have at its secondary side, particularly between the spring set and the teeth to the input hub of the disconnect clutch, a wobble-compensating connection 26 for reducing component stresses and, alternatively or additionally, an added mass 28 which helps to prevent teeth noise and possibly improves the decoupling quality of the torsional damper.
9. A compact disconnect clutch makes it possible to arrange a spur pinion adjacently in axial direction for connecting the electric machine to the transmission input shaft. An input hub of the disconnect clutch can be supported via a pilot bearing in the crankshaft journal of the crankshaft, for example, of an internal combustion engine. A compensation of radial offset in the torsional damper or a radial bearing support for the input hub in the end shield is not necessary. Instead, a radial shaft seal with thrust sleeve and O-ring or thrust ring and a thrust bearing can be arranged.
10. Piston seals and piston running surfaces of pistons of the disconnect clutch can be arranged by laser welding at outer plate carrier and the piston of the disconnect clutch. The inner plate carrier of the disconnect clutch can be connected via a rivet assembly to a hub part which has a spline on the radially outer side to a gear wheel with running teeth and a spline on the radially inner side to a transmission input shaft.

To summarize, the present invention, particularly at least one of the embodiment forms, offers the advantages of a sufficient decoupling of rotational irregularities, a compact installation space, so that the transmission arrangement can be arranged in a predetermined front transverse installation space in a neutral manner with respect to installation space, and a high flexibility with respect to adapting to different boundary constraints.

Although the present invention has been described in terms of preferred embodiment examples, it is not limited to these embodiment examples but rather can be modified in various ways.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCE CHARACTERS

1 transmission arrangement
2 dividing housing element/end shield
3 dual mass flywheel
4 clutch/disconnecting device
5 transmission input shaft
6 mass damper device
7 inner plate carrier
8 outer plate carrier
9 driveshaft
10 spur pinion
11 grooved ball bearing
12 input hub clutch
13 crankshaft
14 thrust ring
15 thrust bearing
16 piston
17 rivet
18 hub
19a, 19b spline
20 torque flow
21 bearing support spur gear
22 pilot bearing
23 flange crankshaft
24 chain
25a, 25b spur gear
NR wet space
TR dry space

1.-20. (canceled)

21. A transmission arrangement for a transmission of a vehicle, comprising:
a dividing housing element configured to divide the transmission arrangement into at least one wet space and at least one dry space;
at least one torsional damper for damping torsional vibrations;
at least one disconnecting device for disconnecting a torque flow of a drive from a transmission input shaft of the transmission;
a mass damper device arranged in a torque flow between a secondary side of the at least one torsional damper and a primary side of the disconnecting device; the at least one torsional damper being arranged in the dry space, and the at least one disconnecting device being arranged in the wet space; and wherein a connection device for an electric machine is arranged and is operatively connected on a radial inner side to a radial outer side of at least one of the at least one disconnecting devices and the mass damper device in the same axial plane as the at least one disconnecting device and mass damper device.

22. The transmission arrangement according to claim 21, wherein the mass damper device is arranged in the dry space.

23. The transmission arrangement according to claim 21, wherein the mass damper device is configured to damp vibrations of at least one of a first order and a second order.

24. The transmission arrangement according to claim 21, wherein the mass damper device is connected on one side to the disconnecting device.

25. The transmission arrangement according to claim 21, wherein the torsional damper has a wobble-compensating connection element in a torque flow on a secondary side of the torsional damper.

26. The transmission arrangement according to claim 21, wherein the torsional damper has an added mass element in the torque flow on a secondary side of the torsional damper.

27. The transmission arrangement according to according to claim 21, wherein the torsional damper is constructed to compensate a radial offset between a driveshaft connected to a primary side of the torsional damper, and an input element of the disconnecting device.

28. The transmission arrangement according to claim 21, wherein the connection device is connected to a secondary side of the disconnecting device.

29. The transmission arrangement according to claim 21, wherein the disconnecting device is a clutch.

30. The transmission arrangement according to claim 29, wherein a secondary side of the clutch is formed by an outer plate carrier and a primary side is formed by an inner plate carrier.

31. The transmission arrangement according to claim 21, wherein a primary side element of the disconnecting device and the mass damper device are supported in the dividing housing element via a grooved ball bearing.

32. The transmission arrangement according to claim 21, wherein the dividing housing element is arranged so that the wet space forms an interior space of the transmission.

33. The transmission arrangement according to claim 21, wherein the mass damper device is arranged substantially in radial direction inside of a maximum radial extent of the torsional damper and substantially in the same axial plane.

34. A transmission arrangement for a transmission of a vehicle comprising:
a dividing housing element configured to divide the transmission arrangement into at least one wet space and at least one dry space;
at least one torsional damper for damping torsional vibrations;
at least one disconnecting device for disconnecting a torque flow of a drive from a transmission input shaft of the transmission; the at least one torsional damper being arranged in the dry space and the at least one disconnecting device being arranged in the wet space, and a connection device for an electric machine is arranged in the wet space; and wherein the connection device extends in a radial direction and is arranged adjacent to the disconnecting device in an axial direction on a secondary side of the disconnecting device.

35. The transmission arrangement according to claim 34, wherein the torsional damper has a wobble-compensating connection element in a torque flow on a secondary side of the torsional damper.

36. The transmission arrangement according to claim 34, wherein the connection device is constructed in the form of a spur pinion, wherein at least one rotational axis of the spur pinion is arranged in a radial direction within the maximum radial extent of the disconnecting device.

37. The transmission arrangement according to claim 34, additionally comprising a pilot bearing in a shaft and wherein an input element of the disconnecting device is supported by the pilot bearing connected to a primary side of the torsional damper.

38. The transmission arrangement according to claim 34, wherein the dividing housing element is supported by a) a thrust sleeve and at least one sealing element or b) a thrust ring and a thrust bearing.

39. The transmission arrangement according to claim 34, wherein the disconnecting device comprises at least one actuating element, wherein a sealing element and/or a running surface of an actuating element are fastened to a primary side of the disconnecting device by laser welding.

40. The transmission arrangement according to claim 34, additionally comprising a hub having a radially inner side and radially outer side; and
wherein a secondary side of the disconnecting device is connected via a rivet connection to the hub, and further comprising a spline for connecting to a transmission input shaft, the spline being arranged on the radial inner side and radial outer side of the hub.
